(19) United States
(12) Patent Application Publication
(10) Pub. No.: US 2022/0011338 A1
(43) Pub. Date: Jan. 13, 2022

(54) TRIAXIAL INDUSTRIAL ACCELEROMETER

(71) Applicant: AUTOVIB, Miserey-Salines (FR)

(72) Inventor: Brunner Ange, MISEREY-SALINES (FR)

(73) Assignee: AUTOVIB, MISEREY-SALINES (FR)

(21) Appl. No.: 17/323,606

(22) Filed: May 18, 2021

(30) Foreign Application Priority Data
Jul. 7, 2020 (FR) 2007175

(51) Int. Cl. G01P 15/18; G01P 1/00

(52) U.S. Cl. CPC G01P 15/18; G01P 1/00

(57) ABSTRACT

The invention relates to an industrial accelerometer, in particular for monitoring the vibration of an industrial machine. The accelerometer comprises a first and a second microelectromechanical integrated circuit arranged on a planar printed circuit, the first integrated circuit constituting a first triaxial sensor capable of supplying acceleration signals along the three measurement axes, the second integrated circuit constituting a second monoaxial sensor capable of supplying an acceleration signal along a single measurement axis. The first and second integrated circuits are arranged on the planar printed circuit so that the single measurement axis of the second sensor is parallel to one of the three measurement axes of the first sensor.

### FIELD OF THE INVENTION

The present invention relates to a triaxial accelerometer which may be applicable to the measurement of vibrations of industrial machines, in particular of rotating machines.

### BACKGROUND OF THE INVENTION

The mechanical state of an industrial machine such as a rotating machine (a compressor, a turbine, a pump for example) can be monitored by measuring and analyzing its vibrations. Traditionally, the vibration measurement is carried out by means of a piezoelectric accelerometer which is secured, generally by means of a fixing stud, to a vibrating element of the machine. This type of accelerometer is available in a triaxial version, that is to say, it is able to provide measurements along three measurement axes of a rectangular trihedron, so as to fully characterize the vibratory phenomena of the machine. Piezoelectric accelerometers have the advantage of having a linear behavior over a wide range of frequencies (between a few tenths of Hz and 10 kHz or 20 kHz) and of having a wide dynamic range (for example between 1 g and 5 g). However, they are relatively bulky and expensive.

Acceleration sensors are also known in the form of microelectromechanical integrated circuits, manufactured using microelectronic techniques, and often referred to as “MEMS accelerometer” (from the acronym “Micro ElectroMechanical Systems”). These sensors are generally very compact and relatively inexpensive, but nevertheless have characteristics which have reserved their applications for measuring “static” acceleration or acceleration having a reduced frequency, typically less than a few kHz. These characteristics make them incompatible with the vibration monitoring of industrial machines, for which the frequency range to be monitored typically extends from 0.1 Hz to 10 kHz or 20 kHz.

More recently, advances in the field of microelectromechanical systems have made it possible to propose monoaxial MEMS sensors, the measurement axis extending in the plane of the sensor, able to perform acceleration measurements in higher frequency ranges, up to 20 kHz or even 40 kHz. This extended range of frequencies, combined with a reduced signal-to-noise ratio and increased measurement dynamics compared to previous generation accelerometers, makes it possible to consider using these sensors in the field of vibration monitoring for industrial machinery. However, these components are not available in a triaxial configuration, which greatly hinders their uses.

Documents US20110295546 and US2016003863 teach triaxial accelerometers combining a plurality of MEMS sensors arranged on a plurality of planar printed circuits to form a 3D structure, so as to place the measurement axes of the MEMS sensors along the 3 axes of the rectangular measurement trihedron of the accelerometer. This solution is not suitable, however, because the 3D assembly of the printed circuits is complex to produce, not very compact, and above all, leads to spurious resonances appearing on the frequency response of the accelerometer, which disturbs the measurement and makes it somewhat unreliable.

Document US2005122100 in turn proposes to assemble a magnetic sensor vertically, on its edge, to provide a measurement along a vertical axis. This unconventional approach cannot be deployed industrially.

### SUBJECT MATTER OF THE INVENTION

One aim of the invention is to provide a triaxial accelerometer which at least partially overcomes these drawbacks. More precisely, the present invention aims to provide a triaxial industrial accelerometer comprising sensors which are capable of supplying acceleration signals and in the form of microelectromechanical integrated circuits, the industrial accelerometer being able to be used for the vibration monitoring of an industrial machine, and in particular a rotating machine. The present invention aims in particular to provide a triaxial industrial accelerometer that is more reliable than those, using microelectromechanical sensors, proposed in the state of the art.

### SUMMARY OF THE INVENTION

With a view to achieving this aim, the object of the invention proposes an industrial accelerometer capable of providing measurements along three measurement axes of a rectangular trihedron, in particular for the vibration monitoring of an industrial machine, the accelerometer comprising a first and a second microelectromechanical integrated circuit arranged on a planar printed circuit;

the first integrated circuit extending along a first plane and constituting a first triaxial sensor capable of supplying acceleration signals along the three measurement axes, two measurement axes residing in the first plane;
the second integrated circuit extending along a second plane and constituting a second monoaxial sensor capable of supplying an acceleration signal along a single measurement axis residing in the second plane.

According to the invention, the first and second integrated circuits are arranged on the planar printed circuit so that the single measurement axis of the second sensor is parallel to one of the two measurement axes residing in the first plane of the first sensor, the other two axes being referred to as the “preserved axes.” The measurements provided by the industrial accelerometer are composed of the acceleration signal from the second sensor and the two acceleration signals along the two preserved axes of the first sensor.

According to other advantageous and non-limiting features of the invention, taken alone or in any technically feasible combination:
the first integrated circuit and the second integrated circuit are respectively arranged on two opposite faces of the planar printed circuit;
the first integrated circuit and the second integrated circuit are arranged on the same face of the planar printed circuit;
the planar printed circuit is arranged in a rigid tubular body;
the planar printed circuit is connected to an electrical connector or an integral cable;
the planar printed circuit is rigid;
the planar printed circuit is flexible;
the planar printed circuit also carries a conditioning circuit;
the second monoaxial sensor has at least one improved characteristic compared to the characteristics of the first triaxial sensor.

According to another aspect, the invention also proposes a use of an industrial accelerometer as explained above for the vibration monitoring of an industrial machine having a main axis of vibration, the use comprising the fixing of the accelerometer on the industrial machine such that the single measurement axis of the second sensor is parallel to the main axis of vibration of the industrial machine.

According to yet another aspect, the invention provides a system comprising an industrial machine having a main axis of vibration and, fixed to this industrial machine, an industrial accelerometer in accordance with the invention, the single measurement axis of the second sensor being parallel to the main axis of vibration.

### BRIEF DESCRIPTION OF THE DRAWINGS

Other features and advantages of the invention will become apparent from the following detailed description of the invention, which is provided with reference to the appended drawings, in which:

FIG. 1 shows an industrial accelerometer according to one embodiment;

FIGS. 2 and 3 schematically show two embodiments of the measurement electronics of an accelerometer according to the invention;

FIGS. 4 and 5 illustrate the use of an accelerometer according to the invention for the vibration monitoring of a bearing and a belt.

### DETAILED DESCRIPTION OF THE INVENTION

For the sake of simplifying the following description, the same reference signs are used for elements which are identical or perform the same function in the different described embodiments of the invention.

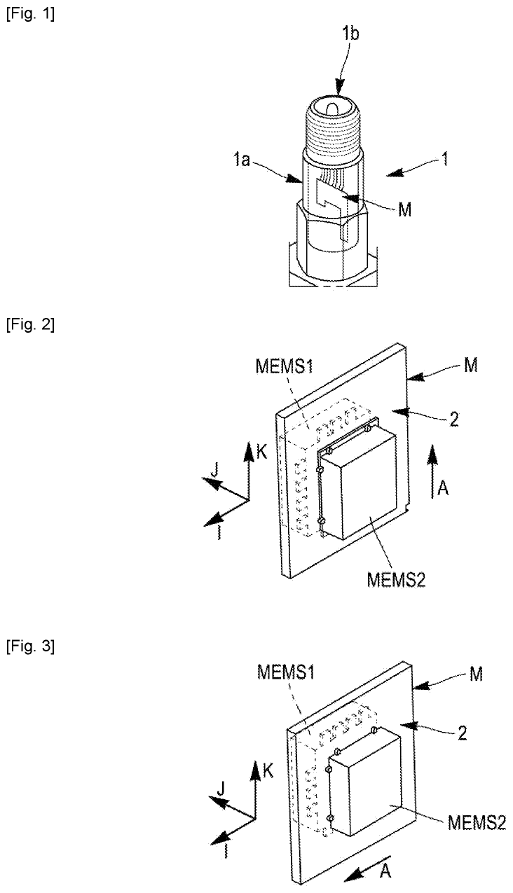

FIG. 1 shows an industrial accelerometer 1 according to one embodiment. The accelerometer 1 here is formed by a rigid tubular body constituting a casing 1a in which the measurement electronics M are housed. The rigid body can be made of steel or aluminum. A threaded hole made at a first end of the rigid body makes it possible to fix the accelerometer to an industrial machine, by means of a fixing stud. The other end of the rigid body comprises an electrical connector 1b in order to connect the accelerometer 1 using a cable suitable for a remote analysis system, as is well known per se.

Other configurations of industrial accelerometers are of course possible. The rigid body may in particular have a shape other than the tubular shape taken here as an example. It may for example have the shape of a parallelepiped. Although stud fixing is the preferred form of fixing, it is not necessary either, and it is possible to envisage fixing the accelerometer to the industrial machine to be monitored by any other means, for example by means of an adhesive or by magnetization. Likewise, the electrical connector 1b as shown in FIG. 1 does not form an essential characteristic, and provision can be made for the measurement electronics M to be able to transmit the acceleration measurements to the remote analysis system by any suitable means and according to any format and any standard, for example by wireless transmission of these measurements after their digital or analog conversions by 2 or 3 wire connection, for example according to the IEPE standard (from the English expression “Integrated Electronic PiezoElectric”). Provision can also be made for the industrial accelerometer 1 to have no connector and for the measurement electronics to be directly connected to an integral non-removable connecting cable.

Whatever the exact form taken by the industrial accelerometer 1, it is said to be “triaxial,” that is to say, it is able to provide acceleration measurements along the three measurement axes of a rectangular trihedron, these measurements being produced by the measurement electronics M, two embodiments of which are shown schematically in FIGS. 2 and 3.

With reference to these figures, the measurement electronics M comprise a planar printed circuit 2 on which the various electronic components are arranged. The term “planar printed circuit” denotes a printed circuit residing in a single plane, and preferably a single planar printed circuit. The printed circuit is not formed by a plurality of printed circuits assembled together in 3D as is the case in the solutions of the state of the art; the measurement electronics M are therefore simple to manufacture, compact, and will not or are unlikely to cause spurious resonances to appear on the frequency response of the accelerometer 1.

The planar printed circuit 2 can be a rigid plate, for example made up of insulating epoxy layers reinforced by a network of glass fibers. Alternatively, it can be chosen to be flexible and made from a fine insulating material, for example polyimide. In all cases, the planar printed circuit 2 forms a support for all the components of the measuring electronics M and connects them electrically by means of conductive tracks, as is well known per se. A cable (not shown in the figures) can connect the measurement electronics to the connector 1b, when such a connector is provided. The printed circuit 2 can be single-sided or double-sided, and therefore the components can be arranged on one side of the planar printed circuit 2 or arranged on the two opposite sides of this printed circuit 2.

In the schematic illustrations of FIGS. 2 and 3, the planar printed circuit 2 carries a first microelectromechanical integrated circuit MEMS1 and a second microelectromechanical integrated circuit MEMS2 constituting two different acceleration sensors. The first integrated circuit MEMS1 and the second integrated circuit MEMS2 here are respectively arranged on two opposite sides of the planar printed circuit 2, but it could be envisaged to have them on the same side of this circuit 2, for example side by side. In all cases, the use of a single planar printed circuit allows them to be placed close to one another so that they are precisely subjected to the same accelerations.

Of course, other components can be provided, in particular those making up a conditioning circuit for the acceleration signals supplied by the two sensors MEMS1, MEMS2 with a view to forming the measurements made available on the connector 1b of the industrial accelerometer 1 or transmitted analogically or digitally by any other means. This conditioning can correspond to an amplification of the acceleration signals, to their filtering, to the compensation of the drifts or biases linked to the temperature. It can implement analog or digital processing. It is also possible to provide for placing, on the planar printed circuit 2, a circuit for supplying and/or regulating the supply of the microelectromechanical integrated circuits MEMS1, MEMS2.

Returning to the description of FIGS. 2 and 3, the first integrated circuit MEMS1 constitutes a first triaxial sensor capable of supplying acceleration signals along the three measurement axes I, J, K of the industrial accelerometer 1. The first circuit MEMS1 defines and extends in a first plane. In this first plane, it has two measurement axes I, J which are perpendicular to each other. The first circuit MEMS1 also comprises a third measurement axis K which is arranged in a direction perpendicular to the first plane. The second integrated circuit MEMS2 constitutes a second monoaxial sensor which is capable of supplying an acceleration signal along a single measurement axis A. The second integrated circuit MEMS2 defines and extends in a second plane. The single measurement axis A resides in this second plane. The first and second planes of the integrated circuits MEMS1, MEMS2 correspond to their assembly plane, that is to say, when these circuits MEMS1, MEMS2 are functionally mounted on a printed circuit, the first and second planes are both coplanar with the printed circuit.

As was presented in the introductory part of this application, the second monoaxial sensor MEMS2 has improved characteristics compared to the characteristics of the first triaxial sensor MEMS1. For example, the second sensor MEMS2 can have a constant sensitivity (within 10%) over a wider frequency range than that of the first sensor MEMS1. The frequency range of constant sensitivity can thus extend between 0.2 Hz and 10 kHz or even 20 kHz for the second sensor MEMS2, and be limited to the frequency range between 0.2 Hz and 4 kHz or 6 kHz for the first sensor MEMS1. Alternatively or in addition, the measurement noise of the second sensor MEMS2, for example 30 micro-g per root Hz or less, is less than the measurement noise of the first sensor MEMS1, which can be of the order of 80 micro-g per root Hz or more. Or the measurement dynamic of the second sensor MEMS2 (which can be of the order of 100 g or more) is strictly greater than the measurement dynamic of the first sensor MEMS1 (which can be of the order of 40 g).

To take advantage of the better performance of the second sensor MEMS2 relative to the first, it is provided to arrange the first integrated circuit MEMS1 and the second integrated circuit MEMS2 on the planar printed circuit 2 so that the single measurement axis A of the second sensor is parallel to one of the two measurement axes I, J of the first sensor MEMS1 residing in the first plane of the first integrated circuit MEMS1.

Thus in FIGS. 2 and 3, the first integrated circuit MEMS1 constituting the first triaxial sensor has two measurement axes I, J in the first plane and coplanar with the planar printed circuit 2 and a measurement axis K normal to the printed circuit 2. The second MEMS2 integrated circuit constituting the second monoaxial sensor has a single measurement axis A in the second plane, also coplanar with the planar printed circuit 2. The two integrated circuits MEMS1, MEMS2 are oriented with respect to each other to align the single measurement axis A of the second integrated circuit MEMS2 with one of the two coplanar axes I, J of the first integrated circuit MEMS1, which results in the two possible configurations respectively shown in FIGS. 2 and 3. In the remainder of this description, “preserved axes” will denote the measurement axes of the first integrated circuit MEMS1 which are not parallel to the single measurement axis A of the second integrated circuit MEMS2.

To develop the measurements supplied by the industrial accelerometer 1, the signal supplied by the first sensor MEMS1 along the axis I, J parallel to the single measurement axis A is replaced by the signal supplied by the second sensor MEMS2. In other words, the measurements provided by the industrial accelerometer 1 are composed of the acceleration signal from the second sensor MEMS2 and the two acceleration signals along the two preserved axes of the first sensor MEMS1.

In this way, the improved characteristics of the second sensor MEMS2 are taken advantage of. The acceleration measurement provided by the accelerometer 1 along the axis of the rectangular trihedron corresponding to the single measurement axis A of the second sensor MEMS2 is naturally more representative of the real acceleration. Preferably, the accelerometer 1 is placed on industrial equipment to monitor the vibration thereof so that the axis of the rectangular trihedron corresponding to the single measurement axis A of the second sensor MEMS2 is at least partly parallel to the main component of the acceleration vector to be measured. In this way, it is possible to take advantage of all the measurement dynamics available on each of these three axes.

The two configurations shown in FIGS. 2 and 3 make it possible, when the measurement electronics M are arranged in the same rigid body of the casing 1a, to have accelerometers whereof the single measurement axis A of the second sensor MEMS2 can be respectively oriented in two different directions (and perpendicular to each other). In this way, it is possible to equip industrial machines with various main axes of vibration with an accelerometer having the same form factor.

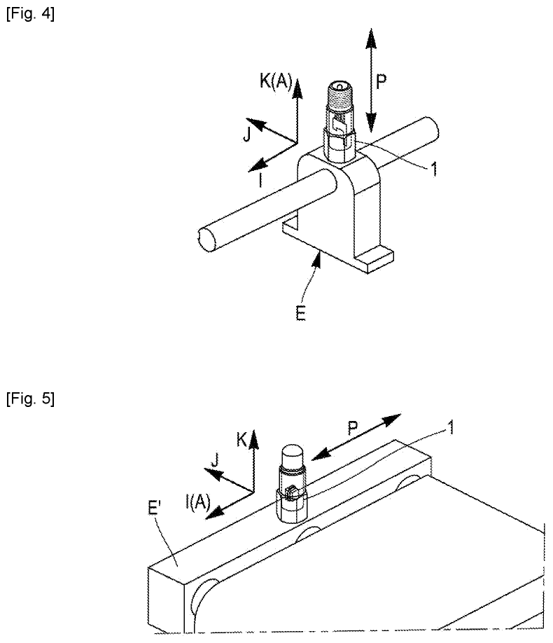

By way of illustration of the use of an accelerometer 1 in accordance with the invention, FIG. 4 shows a vibration measurement of a bearing, this arrangement forming a machine E. The main axis of vibration P of such a measurement is perpendicular to the axis of a shaft, here perpendicular to the mounting surface on a bearing. In this configuration, the arrangement of FIG. 2 makes it possible to align the single measurement axis A of the second sensor MEMS2 with the main axis of vibration P. When the accelerometer 1 comprises a rigid tubular casing body as shown in FIG. 4, the single measurement axis can be aligned with the longitudinal axis of the tubular body. FIG. 5 shows a vibratory measurement of a belt or of a hopper moving in translation in a main direction which defines the main axis of vibration P of this machine E′. In this case, the arrangement of FIG. 3 makes it possible to align the measurement axis A of the second sensor MEMS2 with the main axis of vibration P of this machine E′. When the accelerometer 1 comprises a rigid tubular casing body as shown in FIG. 5, the single measurement axis can be perpendicular to the longitudinal axis of the tubular body.

Note that for machines with a main axis of vibration, the need for a measurement on the other two axes is less demanding: the extent of the frequency range, the dynamics and/or the expected noise level may be less than along the main axis.

Of course, the invention is not limited to the embodiments described and it is possible to add variants without departing from the scope of the invention as defined by the claims.

1. An industrial accelerometer capable of providing measurements along three measurement axes of a rectangular trihedron in particular for the vibration monitoring of an industrial machine, the accelerometer comprising:
a first and a second microelectromechanical integrated circuit arranged on a planar printed circuit;
the first integrated circuit extending along a first plane and constituting a first triaxial sensor capable of supplying acceleration signals along the three measurement axes, two measurement axes residing in the first plane;
the second integrated circuit extending along a second plane and constituting a second monoaxial sensor capable of supplying an acceleration signal along a single measurement axis residing in the second plane; and
the first and the second integrated circuit being arranged on the planar printed circuit so that the single measurement axis of the second sensor is parallel to one of the two measurement axes residing in the first plane of the first sensor, the other two axes being designated as the preserved axes, the measurements provided by the industrial accelerometer being composed of the acceleration signal from the second sensor and the two acceleration signals along the two preserved axes of the first sensor.

2. The industrial accelerometer according to claim 1, wherein the first integrated circuit and the second integrated circuit are respectively arranged on two opposite faces of the planar printed circuit.

3. The industrial accelerometer according to claim 1, wherein the first integrated circuit and the second integrated circuit are arranged on the same face of the planar printed circuit.

4. The industrial accelerometer according to claim 1, wherein the planar printed circuit is arranged in a rigid tubular body.

5. The industrial accelerometer according to claim 1, wherein the planar printed circuit is connected to an electrical connector or an integral cable.

6. The industrial accelerometer according to claim 1, wherein the planar printed circuit is rigid.

7. The industrial accelerometer according to claim 1, wherein the planar printed circuit is flexible.

8. The industrial accelerometer according to claim 7, wherein the planar printed circuit carries a conditioning circuit.

9. The industrial accelerometer according to claim 1, wherein the second monoaxial sensor has at least one improved characteristic compared to the characteristics of the first triaxial sensor.

10. A method for using an industrial accelerometer having a main axis of vibration, comprising:
providing a first and a second microelectromechanical integrated circuit arranged on a planar printed circuit, the first integrated circuit extending along a first plane and constituting a first triaxial sensor capable of supplying acceleration signals along the three measurement axes, two measurement axes residing in the first plane, the second integrated circuit extending along a second plane and constituting a second monoaxial sensor capable of supplying an acceleration signal along a single measurement axis residing in the second plane; and
fixing the accelerometer on an industrial machine such that the single measurement axis of the second sensor is parallel to the main axis of vibration of the industrial machine.

11. The method according to claim 10, further comprising arranging the first integrated circuit and the second integrated circuit on two opposite faces of the planar printed circuit.

12. The method according to claim 10, further comprising arranging the first integrated circuit and the second integrated circuit on the same face of the planar printed circuit.

13. The method according to claim 10, further comprising arranging the planar printed circuit in a rigid tubular body.

14. The method according to claim 10, further comprising connecting the planar printed circuit to an electrical connector or an integral cable.

15. The method according to claim 10, wherein the planar printed circuit is rigid.

16. The method according to claim 10, wherein the planar printed circuit is flexible.

17. The method according to claim 16, wherein the planar printed circuit carries a conditioning circuit.

18. The method according to claim 10, wherein the second monoaxial sensor has at least one improved characteristic compared to the characteristics of the first triaxial sensor.
